(19) United States
(12) Patent Application Publication
(10) Pub. No.: US 2025/0220483 A1
(43) Pub. Date: Jul. 3, 2025

(54) FILTERING MDT MEASUREMENTS BASED ON LOCATION

(71) Applicant: Telefonaktiebolaget LM Ericsson (publ), Stockholm (SE)

(72) Inventors: Changwoo Hong, Seoul (KR); Changwoo Sun, Seoul (KR); Pradeepa Ramachandra, Linköping (SE)

(21) Appl. No.: 18/853,860

(22) PCT Filed: Feb. 24, 2023
(86) PCT No.: PCT/EP2023/054711

§ 371 Date: Oct. 3, 2024

(30) Foreign Application Priority Data
Apr. 4, 2022 (WO) PCT/EP2022/058884

(51) Int. Cl. H04W 24/10; H04W 64/00

(52) U.S. Cl. CPC H04W 24/10; H04W 64/00

(57) ABSTRACT

Various embodiments of the present disclosure provide a method for Minimization of Drive Test (MDT) measurement. The method comprises receiving a configuration from a network node. The configuration indicates the terminal device to perform Minimization of Drive Test (MDT) measurement and/or store the MDT measurement result only when location information is available, and/or indicates the terminal device to report only location information tagged MDT measurements.

### TECHNICAL FIELD

Embodiments of the present disclosure relate to communication networks, and more specifically, to methods and apparatuses for Minimization of Drive (MDT) measurements.

### BACKGROUND

This section introduces aspects that may facilitate a better understanding of the disclosure. Accordingly, the statements of this section are to be read in this light and are not to be understood as admissions about what is in the prior art or what is not in the prior art.

In Long-Term Evolution (LTE)/New Radio (NR), Minimization of Drive Tests (MDT) has been introduced to provide a remote method to use for troubleshooting or verification of the radio network that is simpler and cheaper than traditional drive tests. It is a tool to optimize network planning with the MDT measurement data including location information.

For operators, the traditional drive test, where vehicles with measurement equipment are used for analyzing network coverage and capacity, is costly and requires planning and coordination of resources. In the field, it is desirable to use automated drive test solutions, including involvement of User Equipment (UE), for easier operation.

3rd Generation Partnership Project (3GPP) specified MDT so that standard mobiles can be used for measurements to provide data for the operators. This includes Global Navigation Satellite System (GNSS) location information, if available in the User equipments (UEs). MDT provides a simpler, cheaper, and remote method to use for troubleshooting or verification of the radio network.

There are two modes for the MDT measurements: Logged MDT and Immediate MDT.

Logged MDT is a type of MDT where the UE stores the collected data for a certain period of time before the data is reported to the network. This type of MDT is performed when the UE is in idle state (i.e., the UE has no setup connection with the Radio Access Network (RAN) node).

Immediate MDT is a type of MDT where the UE promptly reports the collected data to the network. This type of MDT is performed when the UE is in active state (i.e., the UE has a setup connection with the RAN node).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For logged MDT that involves UE-based measurements (e.g., downlink (DL) radio measurements Reference Signal Received Power (RSRP) and Reference Signal Received Quality (RSRQ)), both radio measurements and location information are measured/acquired at the UE.

However, location information is based on available location information in the UE. Thus, the Logged MDT measurements are tagged by the UE with location data in the following manner: Location information can be included only if it is available in the UE at the time when the measurement was taken.

From network operator perspective, it is obvious that location information tagged MDT measurements are much more useful and valuable because it gives the exact physical location where the measurement was taken. If MDT measurement does not include associated location information, its availability is highly limited to operators.

Also, operators had claimed that quantity of location information tagged MDT measurement is much less compared to quantity of MDT measurements that do not include location information. It brings negative costs to collect MDT measurements that do not include location information even though it is less valuable in operator's perspective especially considering the majority of the Logged MDT measurements do not include location information.

In summary, current solution has the following problems:
There is no option for MDT function to collect/report only location information tagged Logged MDT measurements.
Much portion of MDT measurements do not include associated location information.
UE memory/storage could be fully occupied by less valuable MDT measurements.
NR/LTE network could consume much Radio Resource Control (RRC) resource in order to transmit less valuable/important Logged MDT measurements from UEs.

The present disclosure proposes an improved solution of MDT measurements.

### SUMMARY OF DISCLOSURE

According to a first aspect of the present disclosure, there is provided a method implemented at a terminal device. The method comprises receiving a configuration from a network node. The configuration indicates the terminal device to perform Minimization of Drive Test (MDT) measurement and/or store the MDT measurement result only when location information is available, and/or indicates the terminal device to report only location information tagged MDT measurements.

In accordance with an exemplary embodiment, the method according to the first aspect of the present disclosure may further comprise performing the MDT measurement and/or storing the MDT measurement result based on the configuration only when location information is available.

In accordance with an exemplary embodiment, the method according to the first aspect of the present disclosure may further comprise transmitting a report comprising only location information tagged MDT measurement result, or all MDT measurement result regardless of location information tag, to the network node.

In accordance with an exemplary embodiment, the configuration is carried in LoggedMeasurementConfiguration message and/or UeInformationRequest message.

In accordance with an exemplary embodiment, the configuration comprises one or more indicators.

In accordance with an exemplary embodiment, the indicator is LocationInfoOption.

In accordance with an exemplary embodiment, before the step of performing the MDT measurement, the method according to the first aspect of the present disclosure may further comprise determining whether location information is available.

In accordance with an exemplary embodiment, before the step of storing the MDT measurement result, the method according to the first aspect of the present disclosure may further comprise determining whether the MDT measurement result is tagged with location information.

In accordance with an exemplary embodiment, the location information comprises at least one of: Global Navigation Satellite System (GNSS) information, Wireless Local Area Network (WLAN) information, and Bluetooth beacon information.

In accordance with an exemplary embodiment, the method according to the first aspect of the present disclosure may further comprise transmitting an indication of existence of MDT measurement result with location information to the network node.

In accordance with an exemplary embodiment, the indication is carried in at least one of: RRCSetupComplete message, RRCResumeComplete message, RRCReconfigurationComplete message, or RRCReestablishmentComplete message.

In accordance with an exemplary embodiment, the location information tagged MDT measurement result in the report is for a different network node other than the network node.

In accordance with an exemplary embodiment, the report is carried in a UeInformationResponse message.

In accordance with an exemplary embodiment, before the step of transmitting the report to the network node, the method according to the first aspect of the present disclosure may further comprise filtering for the location information tagged MDT measurement result.

According to a second aspect of the present disclosure, there is provided an apparatus implemented in a terminal device. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus implemented in a terminal device. The apparatus comprises a receiving module. In accordance with some exemplary embodiments, the receiving module is operable to carry out at least the receiving step of the method according to the first aspect of the present disclosure.

According to a fifth aspect of the present disclosure, there is provided a method implemented at a network node. The method comprises determining a configuration which indicates a terminal device to perform Minimization of Drive Test (MDT) measurement and/or store the MDT measurement result only when location information is available, and/or indicates the terminal device to report only location information tagged MDT measurements. The method further comprises transmitting the configuration to the terminal device.

In accordance with an exemplary embodiment, the method according to the fifth aspect of the present disclosure may further comprise receiving a report comprising only location information tagged MDT measurement result, or all MDT measurement result regardless of location information tag, from the terminal device.

In accordance with an exemplary embodiment, the configuration is carried in LoggedMeasurementConfiguration message and/or UeInformationRequest message.

In accordance with an exemplary embodiment, the configuration comprises one or more indicators.

In accordance with an exemplary embodiment, the indicator is LocationInfoOption.

In accordance with an exemplary embodiment, the location information comprises at least one of: Global Navigation Satellite System (GNSS) information, Wireless Local Area Network (WLAN) information, and Bluetooth beacon information.

In accordance with an exemplary embodiment, the method according to the fifth aspect of the present disclosure may further comprise receiving an indication of existence of MDT measurement result with location information from the terminal device.

In accordance with an exemplary embodiment, the indication is carried in at least one of: RRCSetupComplete message, RRCResumeComplete message, RRCReconfigurationComplete message, or RRCReestablishmentComplete message.

In accordance with an exemplary embodiment, the location information tagged MDT measurement result in the report is for a different network node other than the network node.

In accordance with an exemplary embodiment, the report is carried in a UeInformationResponse message.

According to a sixth aspect of the present disclosure, there is provided an apparatus implemented in a network node. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus implemented in a network node. The apparatus comprises a determining module and a transmitting module. In accordance with some exemplary embodiments, the determining module is operable to carry out at least the determining step of the method according to the fifth aspect of the present disclosure. The transmitting module is operable to carry out at least the transmitting step of the method according to the fifth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

With above aspects of the present disclosure, at least one of the problems mentioned above could be solved. Correspondingly, at least one of the following advantages may be achieved:
Provide flexibility to collect more useful and valuable MDT measurements by providing option to configure that UE collects only location information tagged MDT measurements, and/or providing option to fetch only location information tagged MDT measurements.
Secure UE memory/storage by not collecting MDT measurements which do not have associated location information.
Reduce negative network impact at measurement retrieval procedure: NR/LTE network could consume less RRC resource by reporting only valuable/important MDT measurements from UEs.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating Logged MDT procedure;

FIG. 2 is a flowchart illustrating MDT measurement configuration for Logged MDT;

FIG. 3 is a flowchart illustrating UE information procedure;

FIG. 4 is a flowchart illustrating a method according to some embodiments of the present disclosure;

FIG. 5 is a flowchart illustrating another method according to some embodiments of the present disclosure;

FIG. 6 is a block diagram illustrating an apparatus according to some embodiments of the present disclosure;

FIGS. 7A and 7B are block diagrams illustrating other apparatuses according to some embodiments of the present disclosure;

FIG. 8A˜8C are flowcharts illustrating other methods according to some embodiments of the present disclosure;

FIG. 9 is a block diagram illustrating a telecommunication network connected via an intermediate network to a host computer in accordance with some embodiments of the present disclosure;

FIG. 10 is a block diagram illustrating a host computer communicating via a base station with a UE over a partially wireless connection in accordance with some embodiments of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure;

FIG. 13 is a flowchart illustrating a method implemented in a communication system, in accordance with an embodiment of the present disclosure; and

FIG. 14 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like. In the following description, terms “terminal device” and “UE” will be used interchangeably.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

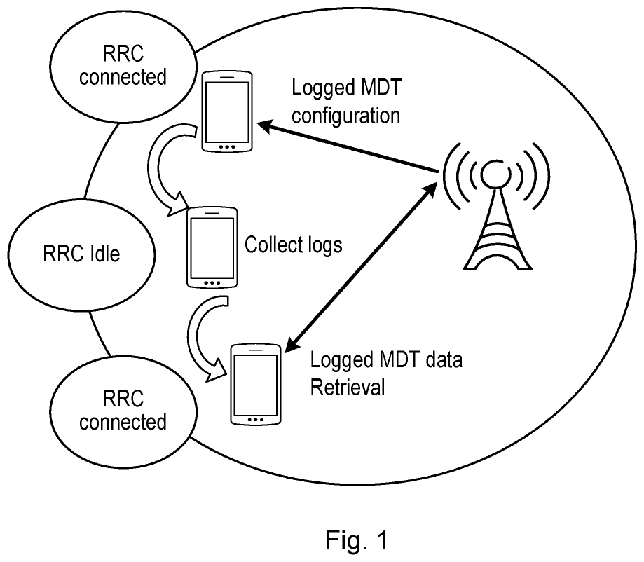

FIG. 1 is a diagram illustrating Logged MDT procedure. Logged MDT procedure consists of 3 phases: Logged MDT configuration, Measurement collection and Measurement retrieval as shown in FIG. 1. Procedure starts when UE receives Logged MDT configuration (LoggedMeasurementConfiguration) message, which is defined in 3GPP TS 36.331 V16.6.0 (available at https://portal.3gpp.org/desktopmodules/Specifications/SpecificationDetails.aspx?specificationId=2440 as of 10 Feb. 2023) for LTE and 3GPP TS 38.331 V16.7.0 (available at https://portal.3gpp.org/desktopmodules/Specifications/SpecificationDetails.aspx?specificationId-3197 as of 10 Feb. 2023) for NR, which are incorporated herein by reference in its entirety.

### Logged MDT Configuration

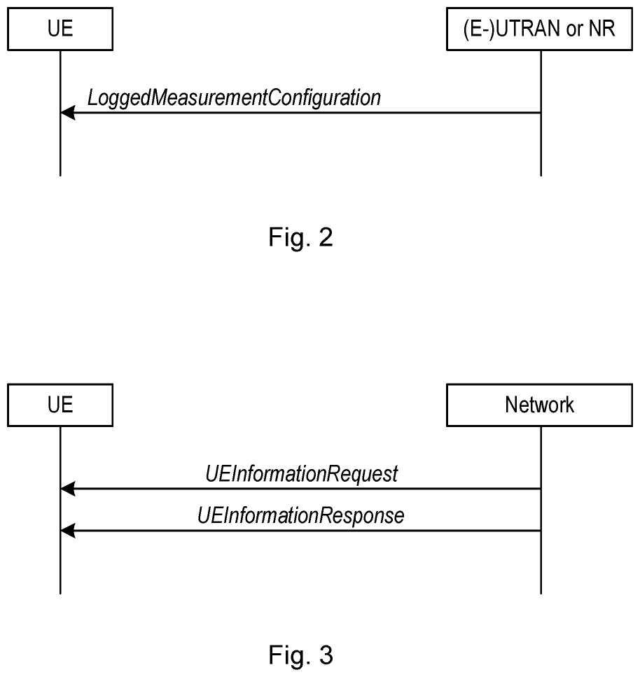

FIG. 2 is a flowchart illustrating MDT measurement configuration for Logged MDT. Network initiates the procedure to UE in RRC Connected by sending LoggedMeasurementConfiguration message, which is used to transfer configuration parameters for Logged MDT. This is a unidirectional RRC signaling procedure.

### Measurement Collection

UE performs MDT measurements and continues logging according to the logged measurement configuration until UE storage reserved for MDT is full.

### Measurement Retrieval

FIG. 3 is a flowchart illustrating UE information procedure. For Logged MDT the measurement reporting is triggered by an on-demand mechanism, i.e., the UE is asked by the network to send the collected measurement logs via RRC signaling. UE Information procedure defined in 3GPP TS 36.331 V16.6.0, chapter 5.6.5 UE Information and TS 38.331 V16.6.0, chapter 5.7.10 UE Information, which is incorporated herein by reference in its entirety, (both as cited above) is used to request UE to send the collected measurement logs. The reporting may occur in different cells than which the logged measurement configuration is signaled.

This solution proposes improvement on Logged MDT Configuration, Measurement Collection and Measurement Retrieval procedures to provide additional flexibility to collect/report only when location information is available.
At the Logged MDT Configuration procedure: New information element (IE) is introduced to provide a configuration parameter that is location Information option about collecting/storing MDT measurements.
At the Measurement Collection procedure: UE can perform MDT measurements or stores MDT measurements data only when location information is available in UE based on new location Information option.
At the Measurement Retrieval procedure: New IE is introduced to provide retrieval option, so UE can report only location information tagged MDT measurements.

This solution introduces new IEs for Logged MDT measurement configuration and for measurement retrieval procedure.

These new IEs can be used to provide flexible options for operators to be able to collect/retrieve MDT measurements. It is to be noted that the measurement configuration and the associated measurement logging forms the main purpose of the invention. The relevant measurement availability indication procedure and the enhanced measurement retrieval procedure can work alone or dependent on each other.

Logged MDT measurement configuration:

RAN (gNodeB or eNodeB) includes new IE, such as Location Information Option when it sends LoggedMeasurementConfiguration message to UEs. The IE indicates that UE shall perform/store MDT measurements only when associated location information is available.

### LocationInfoOption OPTIONAL

LocationInfoOption indicates whether only location information tagged MDT measurement logs are measured/collected.

Further, this new IE can be expanded and provide options regarding Wireless Local Area Network (WLAN) information and/or Bluetooth beacon information.

UE shall be able to include the logged measurements only when the corresponding location info/WLAN info/Bluetooth info is available based on new IE option values.

It could be possible that with no explicit configuration, UE shall log the MDT measurements only when the location information (GNSS specific or WLAN specific or Bluetooth specific) is available.

### Measurement Collection:

UEs perform/collect MDT measurements according to new IE in LoggedMeasurementConfiguration message.
UE checks if location Information is available prior to performing MDT measurements.
UE checks if the MDT measurements are tagged with location data prior storing MDT measurements.

### Relevant Measurement Availability Indication:

The UE which has logged MDT measurements including location information in each of the logged measurement sample, can indicate to the network node (in RRCSetupComplete message or in RRCResumeComplete message or in RRCReconfigurationComplete message or in in RRCReestablishmentComplete message) that it has MDT results with location information. An example implementation is given below for TS 38.331 v16.7.0 (available at https://portal.3gpp.org/desktopmodules/Specifications/SpecificationDetails.aspx?specificationId=3197 as of 10 Feb. 2023).

| | |
|---|---|
| UE-MeasurementsAvailable-r16 ::= | SEQUENCE { |
| logMeasAvailable-r16 | ENUMERATED {true} |

OPTIONAL,

| | |
|---|---|
| logMeasAvailableBT-r16 | ENUMERATED {true} |

OPTIONAL,

| | |
|---|---|
| logMeasAvailableWLAN-r16 | ENUMERATED {true} |

OPTIONAL,

| | |
|---|---|
| connEstFailInfoAvailable-r16 | ENUMERATED {true} |

OPTIONAL,

| | |
|---|---|
| rlf-InfoAvailable-r16 | ENUMERATED {true} |

```
OPTIONAL,
    ...,
    [[
```

| | |
|---|---|
| logMeasWithLocationAvailable-r16 | ENUMERATED {true} |

OPTIONAL,
]]
}

### Measurement Retrieval:

RAN (gNodeB or eNodeB) includes new IE, such as Location Information Option when it sends UeInformationRequest message, which is also defined in 3GPP TS 36.331 V16.6.0 for LTE and 3GPP TS 38.331 V16.7.0 for NR. This IE indicates that UE shall report only location information tagged MDT measurements, or all MDT measurements collected.

LocationInfoOption ENUMERATED {true} OPTIONAL
LocationInfoOption indicates whether only location information tagged Logged MDT measurements are reported.

Further, this new IE can be expanded and provide options Location related information, WLAN information availability or Bluetooth beacon information availability.

UE shall be able to report the logged measurements only when the corresponding location info/WLAN info/Bluetooth info is available based on new IE option values.

eNodeB or gNodeB can be configured that it shall be able to collect/store the MDT measurements only when the location information (GNSS specific or WLAN specific or Bluetooth specific) is available.

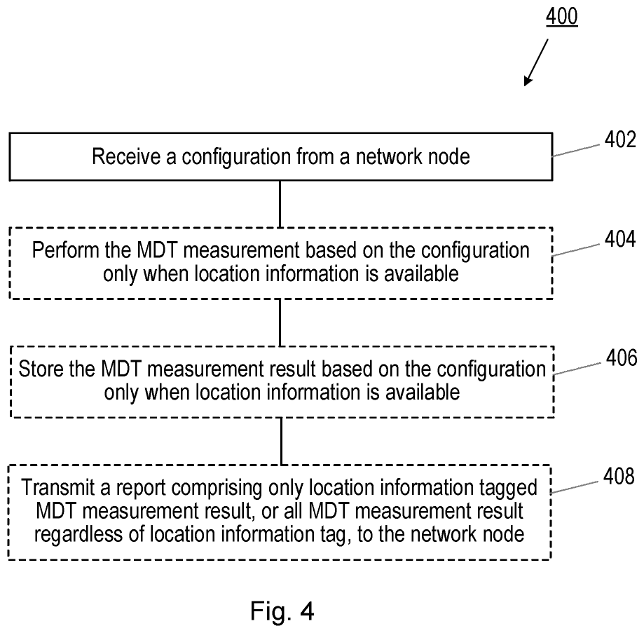

FIG. 4 is a flowchart illustrating a method 400 according to some embodiments of the present disclosure. The method 400 illustrated in FIG. 4 may be performed by an apparatus implemented in a terminal device or communicatively coupled to a terminal device.

According to the exemplary method 400 illustrated in FIG. 4, the terminal device such as a UE can receive a configuration from a network node, as shown in block 402. The configuration indicates the terminal device to perform Minimization of Drive Test (MDT) measurement or store the MDT measurement result only when location information is available, or both of them, preferably by LoggedMeasurementConfiguration message. The configuration instead or additionally indicates the terminal device to report only location information tagged MDT measurements, preferably by UeInformationRequest message.

Optionally, according to the exemplary method 400 illustrated in FIG. 4, the terminal device such as a UE can perform the MDT measurement as shown in block 404. Instead or additionally, the terminal device such as a UE can store the MDT measurement result based on the configuration only when location information is available, as shown in block 406.

Optionally, according to the exemplary method 400 illustrated in FIG. 4, the terminal device such as a UE can transmit a report comprising only location information tagged MDT measurement result, or all MDT measurement result regardless of location information tag, to the network node as shown in block 408.

In accordance with an exemplary embodiment, the configuration is carried in LoggedMeasurementConfiguration message and/or UeInformationRequest message.

In accordance with another exemplary embodiment, the configuration comprises one or more indicators.

In accordance with another exemplary embodiment, the indicator is LocationInfoOption.

In accordance with another exemplary embodiment, before the step of performing the MDT measurement, the terminal device such as a UE can further determine whether location information is available.

In accordance with another exemplary embodiment, before the step of storing the MDT measurement result, the terminal device such as a UE can further determine whether the MDT measurement result is tagged with location information.

In accordance with another exemplary embodiment, the location information comprises at least one of: Global Navigation Satellite System (GNSS) information, Wireless Local Area Network (WLAN) information, and Bluetooth beacon information.

In accordance with another exemplary embodiment, the terminal device such as a UE can further transmit an indication of existence of MDT measurement result with location information to the network node.

In accordance with another exemplary embodiment, the indication is carried in at least one of: RRCSetupComplete message, RRCResumeComplete message, RRCReconfigurationComplete message, or RRCReestablishmentComplete message.

In accordance with another exemplary embodiment, the location information tagged MDT measurement result in the report is for a different network node other than the network node.

In accordance with another exemplary embodiment, the report is carried in a UeInformationResponse message.

In accordance with another exemplary embodiment, before the step of transmitting the report to the network node, the terminal device such as a UE can further filter for the location information tagged MDT measurement result.

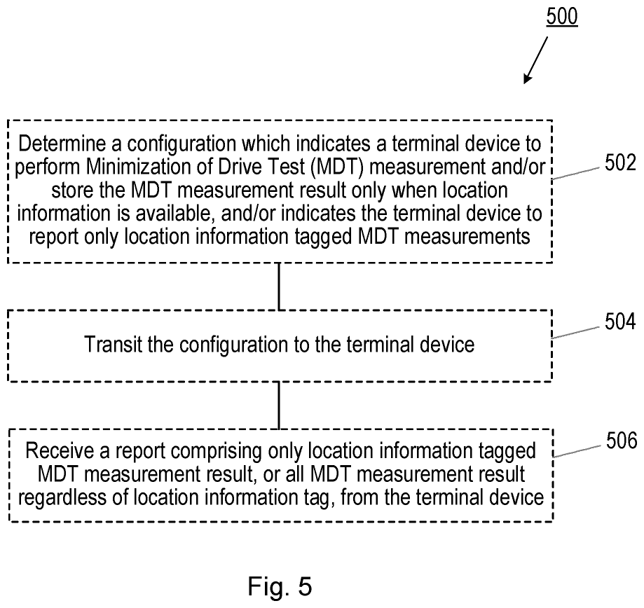

FIG. 5 is a flowchart illustrating a method 500 according to some embodiments of the present disclosure. As described in connection with FIG. 4, the method 500 illustrated in FIG. 5 may be performed by an apparatus implemented in a network node or communicatively coupled to a network node.

According to the exemplary method 500 illustrated in FIG. 5, the network node such as a gNB can determine a configuration, as shown in block 502. The configuration indicates a terminal device to perform Minimization of Drive Test (MDT) measurement or store the MDT measurement result only when location information is available, or both of them. The configuration instead or additionally indicates the terminal device to report only location information tagged MDT measurements. The network node such as a gNB can further transmit the configuration to the terminal device, as shown in block 504, preferably by LoggedMeasurementConfiguration message to indicate the terminal device to perform the MDT measurement or store the MDT measurement result only when location information is available, or by UeInformationRequest message to indicate the terminal device to report the only location information tagged MDT measurements.

Optionally, according to the exemplary method 500 illustrated in FIG. 5, the network node such as a gNB can further receive a report comprising only location information tagged MDT measurement result, or all MDT measurement result regardless of location information tag, from the terminal device, as shown in block 506.

In accordance with an exemplary embodiment, the configuration is carried in LoggedMeasurementConfiguration message and/or UeInformationRequest message.

In accordance with another exemplary embodiment, the configuration comprises one or more indicators.

In accordance with another exemplary embodiment, the indicator is LocationInfoOption.

In accordance with another exemplary embodiment, the location information comprises at least one of: Global Navigation Satellite System (GNSS) information, Wireless Local Area Network (WLAN) information, and Bluetooth beacon information.

In accordance with another exemplary embodiment, the network node such as a gNB can further receive an indication of existence of MDT measurement result with location information from the terminal device.

In accordance with another exemplary embodiment, the indication is carried in at least one of: RRCSetupComplete message, RRCResumeComplete message, RRCReconfigurationComplete message, or RRCReestablishmentComplete message.

In accordance with another exemplary embodiment, the location information tagged MDT measurement result in the report is for a different network node other than the network node.

In accordance with another exemplary embodiment, the report is carried in a UeInformationResponse message.

It will be realized that parameters, variables and settings related to the determination, transmission and reception described herein are just examples. Other suitable network settings, the associated configuration parameters and the specific values thereof may also be applicable to implement the proposed methods.

The proposed solution according to one or more exemplary embodiments can achieve at least one of the following advantages:
Provide flexibility to collect more useful and valuable MDT measurements: provides option to configure that UE collects only location information tagged MDT measurements; and/or provides option to fetch only location information tagged MDT measurements.
Secure UE memory/storage by not collecting MDT measurements which do not have associated location information.
Reduce negative network impact at measurement retrieval procedure: NR/LTE network could consume less RRC resource by reporting only valuable/important MDT measurements from UEs.

The various blocks shown in FIG. 4 and FIG. 5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

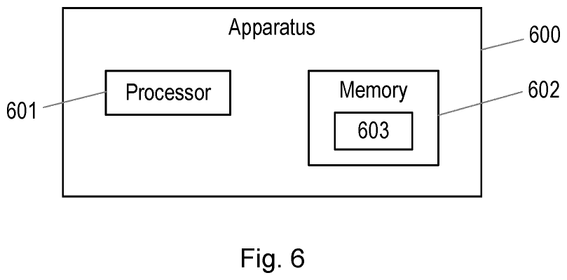

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a terminal device as described with respect to FIG. 4, or a network node as described with respect to FIG. 5.

In some implementations, the one or more memories 602 and the computer program codes 603 may be configured to, with the one or more processors 601, cause the apparatus 600 at least to perform any operation of the method as described in connection with FIG. 4. In other implementations, the one or more memories 602 and the computer program codes 603 may be configured to, with the one or more processors 601, cause the apparatus 600 at least to perform any operation of the method as described in connection with FIG. 5.

Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

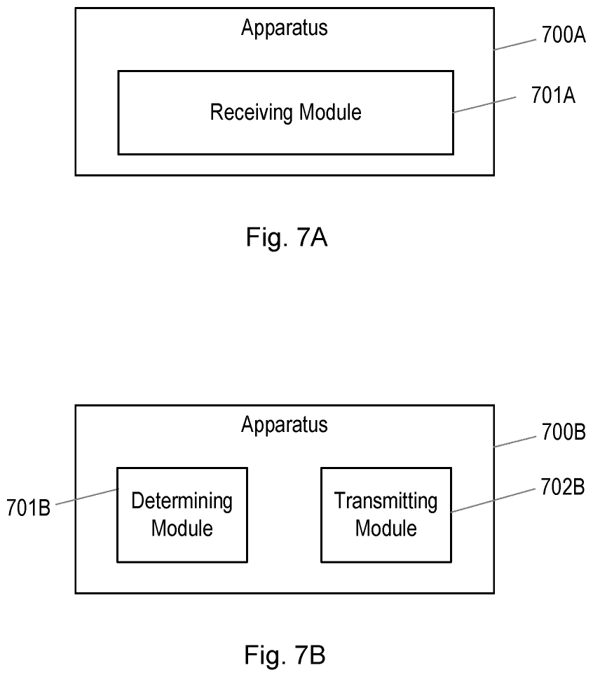

FIG. 7A is a block diagram illustrating an apparatus 700A according to some embodiments of the present disclosure. As shown in FIG. 7A, the apparatus 700A may comprise a receiving module 701A. In an exemplary embodiment, the apparatus 700A may be implemented in a terminal device such as a UE. The receiving module 701A may be operable to carry out the operation in block 402. Optionally, the receiving module 701A may be operable to carry out more or less operations to implement the proposed methods according to the exemplary embodiments of the present disclosure.

FIG. 7B is a block diagram illustrating an apparatus 700B according to some embodiments of the present disclosure. As shown in FIG. 7B, the apparatus 700B may comprise a determining module 701B and a transmitting module 702B. In an exemplary embodiment, the apparatus 700B may be implemented in a network node such as a gNB. The determining module 701B may be operable to carry out the operation in block 502, and the transmitting module 702B may be operable to carry out the operation in block 504. Optionally, the determining module 701B and/or the transmitting module 702B may be operable to carry out more or less operations to implement the proposed methods according to the exemplary embodiments of the present disclosure.

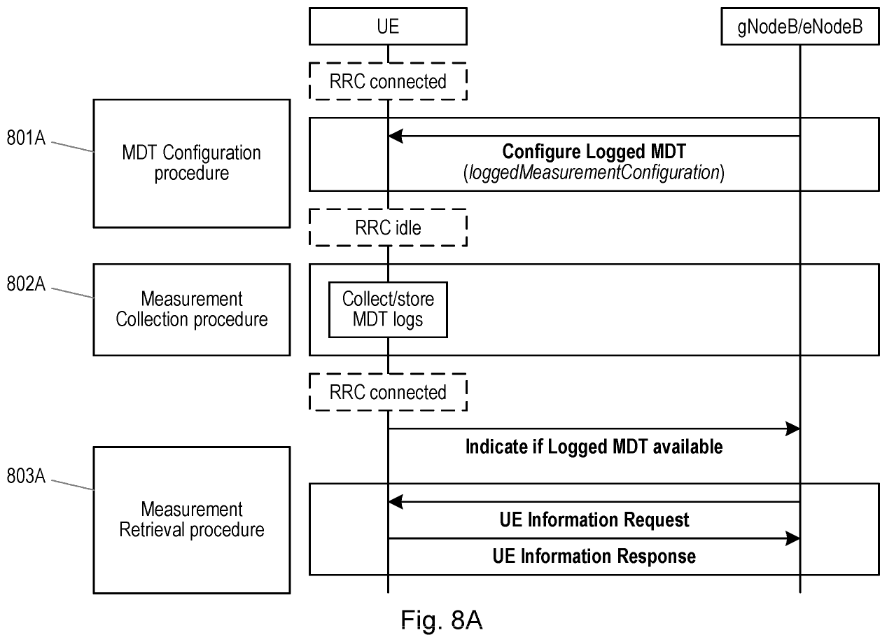

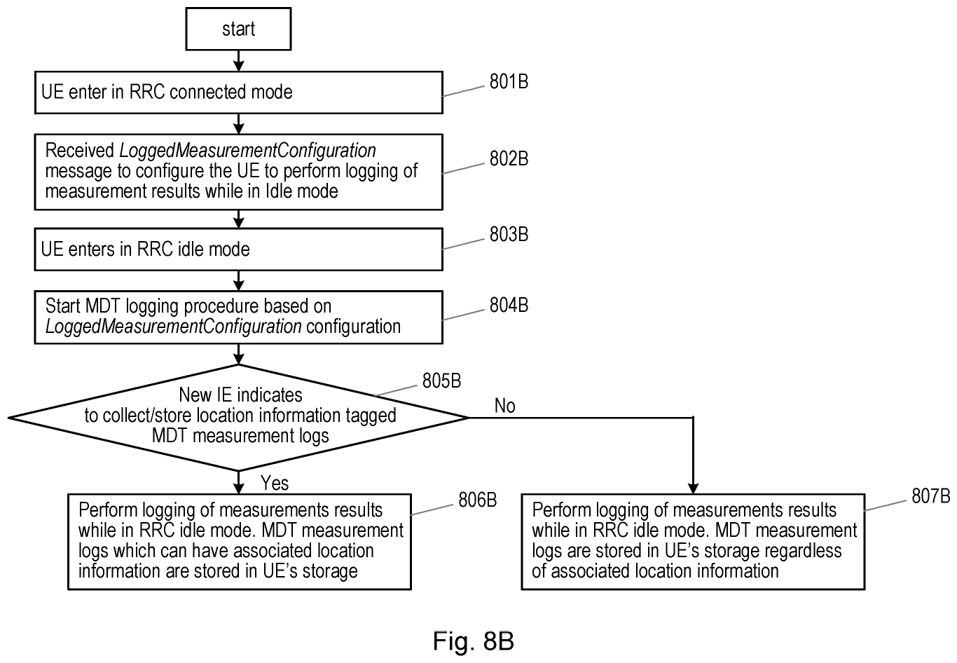

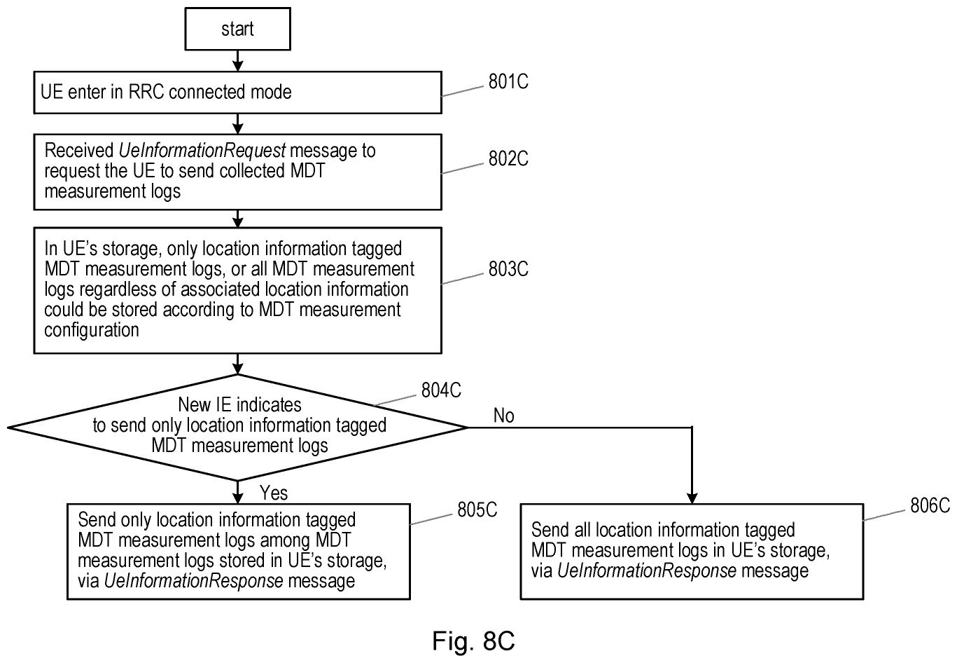

FIG. 8A˜8C are flowcharts illustrating other methods according to some embodiments of the present disclosure.

As illustrated in FIG. 8A, there are three main steps for MDT measurements.

As shown in block 801A, RAN (gNodeB or eNodeB) initiates the logged measurement configuration procedure to UE in RRC connected by sending the LoggedMeasurementConfiguration message.

The LoggedMeasurementConfiguration message is used to configure the UE to perform logging of measurement results while in RRC idle.

New IE in LoggedMeasurementConfiguration message provides an option that only MDT measurements which have associated location information can be collected/sored.

In some embodiments, the UE can be configured with a single indicator in LoggedMeasurementConfiguration for all the location information related configuration that indicates the UE to perform the logging of the measurements only when the location information based on one or more of the positioning method is available.

In some other embodiments, the UE can be configured with separate indicators in LoggedMeasurementConfiguration for the type of location information to be made available. For example, the network can set WLANLocationInfoOption to true to indicate the UE to log the MDT measurements only when the WLAN based measurements are available representing the location information. In another example, the network can set BTLocationInfoOption to true to indicate the UE to log the MDT measurements only when the BT based measurements are available representing the location information. In another example, the network can set SensorLocationInfoOption to true to indicate the UE to log the MDT measurements only when the sensor based measurements are available representing the location information. Here, the sensor configuration can further include explicit indications to indicate which sensor information must be present in each of the MDT logs.

As shown in block 802A, this procedure occurs while UE is in RRC idle. UE performs radio measurements based on LoggedMeasurementConfiguration message. MDT measurement logs are collected/stored in the UE storage.

As shown in block 803A, MDT measurements are retrieved from UE to Network through UE Information procedure. RAN (gNodeB or eNodeB) fetches the MDT measurements through “on demand” mechanism.

New IE in UeInformationRequest message provides an option that only location information tagged MDT measurements can be reported.

MDT measurements retrieval procedure may occur in different cells other than the cell for which the Logged MDT configuration is signaled.

FIG. 8B illustrates MDT configuration and measurement collection procedure.

This invention provides Logged MDT configuration procedure improvement, so UE can perform MDT measurements or store MDT measurements according to location information availability in UEs.

As shown in block 801B, Logged measurement configuration procedure is initiated when UE enters in RRC connected.

As shown in block 802B, upon receiving the LoggedMeasurementConfiguration message, UE stores/configures the received the Logged MDT measurement configuration.

As shown in block 803B, UE starts to initiate measure/collect MDT measurements when UE enters in RRC idle.

As shown in block 804B, Logged MDT measurements are measured/collected based on logged measurement configuration while UE is in RRC idle.

As shown in block 805B, according to new IE in LoggedMeasurementConfiguration message, only location information tagged MDT measurement logs, or all MDT measurement logs regardless of associated location information could be measured/collected in UE's storage.

As shown in block 806B, when new IE indicates to measure/collect only location information tagged MDT measurements, only location information tagged MDT measurements shall be measured/collected in UE's storage.

As shown in block 807B, when new IE indicates to measure/collect all MDT measurements, all MDT measurements shall be measured/collected in UE's storage.

FIG. 8C illustrates MDT Measurement Retrieval procedure.

This invention also provides Measurement Retrieval procedure improvement for the case that UEs are configured by different cell to collect all the MDT measurements regardless of location information. The improved MDT measurement retrieval procedure can filter out MDT measurements in UE storage, so enable to report only location information tagged MDT measurements.

As shown in block 801C, RAN (gNodeB/eNodeB) could initiate a UE to report MDT measurements through UE Information procedure when UE enters in RRC connected.

As shown in block 802C, upon receiving the UeInformationRequest message, UE should prepare to send the collected MDT measurement logs toward gNodeB/eNodeB.

As shown in block 803C, in UE's storage, there could be only location information tagged MDT measurements or all MDT measurements. It depends on new IE in MDT configuration, which is introduced by this invention. From logged MDT perspective, it is possible that UE Information procedure could occur in a different node/cell from a node/cell that MDT configuration is configured.

As shown in block 804C, according to new IE in UeInformationRequest message, only location information tagged MDT measurement logs, or all MDT measurements could be reported by UeInformationReponse message.

As shown in block 805C, when new IE indicates to report only location information tagged MDT measurements, only location information tagged MDT measurement logs shall be reported by using UeInformationReponse message. If necessary, UE must perform filtering function in order to report only location information tagged MDT measurements.

As shown in block 806C, when new IE indicates to report all MDT measurements, all MDT measurements in UE shall be reported by UeInformationReponse message.

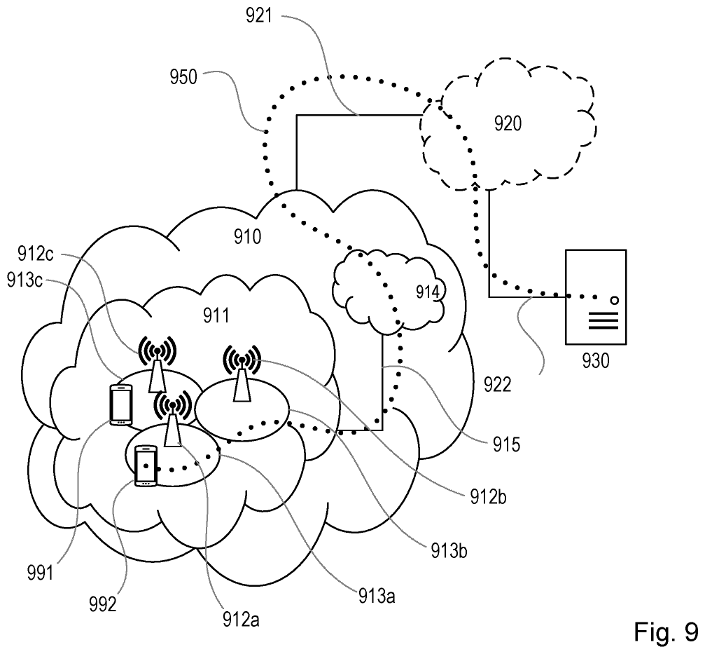

FIG. 9 is a block diagram illustrating a telecommunication network connected via an intermediate network to a host computer in accordance with some embodiments of the present disclosure.

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first UE 991 located in a coverage area 913c is configured to wirelessly connect to, or be paged by, the corresponding base station 912c. A second UE 992 in a coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. Connections 921 and 922 between the telecommunication network 910 and the host computer 930 may extend directly from the core network 914 to the host computer 930 or may go via an optional intermediate network 920. An intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, the base station 912 may not or need not be informed about the past routing of an incoming downlink communication with data originating from the host computer 930 to be forwarded (e.g., handed over) to a connected UE 991. Similarly, the base station 912 need not be aware of the future routing of an outgoing uplink communication originating from the UE 991 towards the host computer 930.

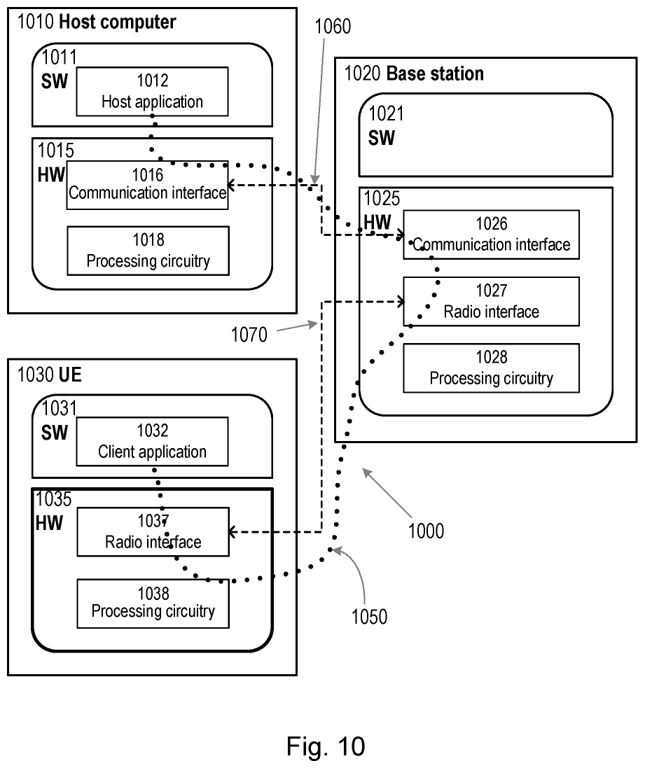

FIG. 10 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises a processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with the UE 1030 located in a coverage area (not shown in FIG. 10) served by the base station 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the base station 1020 further includes a processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes a processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, the base station 1020 and the UE 1030 illustrated in FIG. 10 may be similar or identical to the host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

Wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 1050 between the host computer 1010 and the UE 1030, in response to variations in the measurement results. The measurement procedure and/or the network functionality for reconfiguring the OTT connection 1050 may be implemented in software 1011 and hardware 1015 of the host computer 1010 or in software 1031 and hardware 1035 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which the software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer 1010's measurements of throughput, propagation times, latency and the like. The measurements may be implemented in that the software 1011 and 1031 causes messages to be transmitted, in particular empty or ‘dummy’ messages, using the OTT connection 1050 while it monitors propagation times, errors etc.

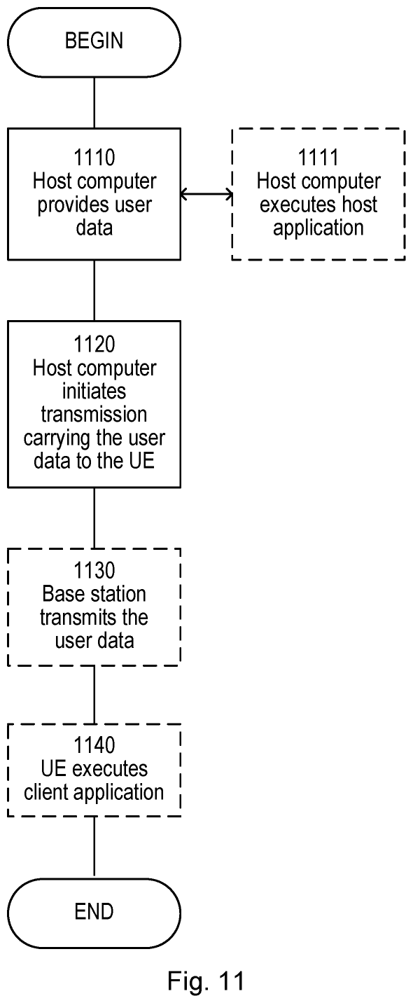

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

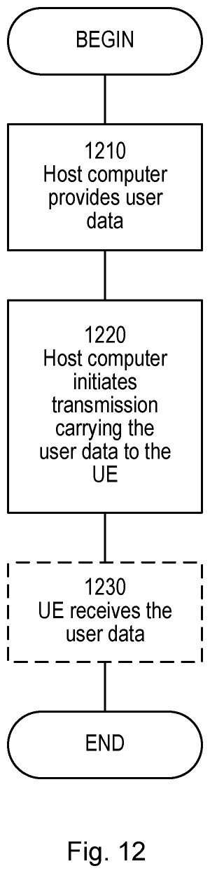

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

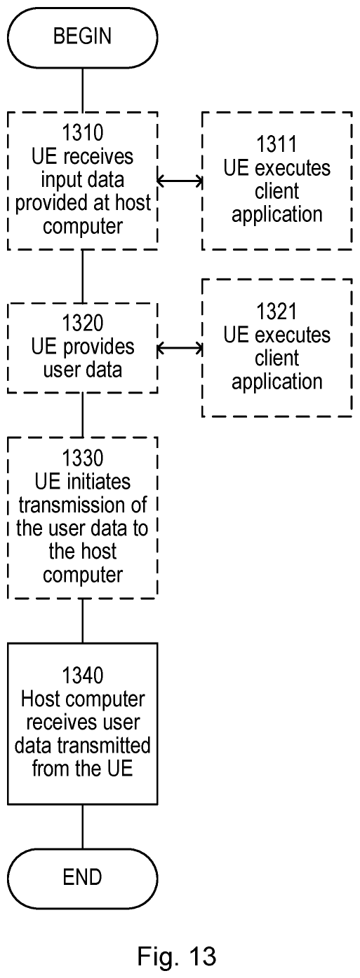

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

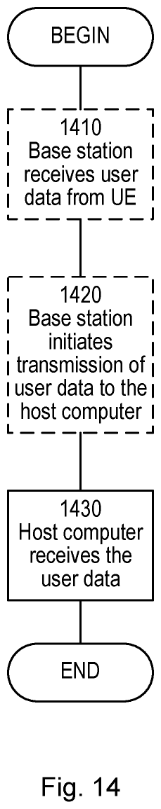

FIG. 14 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method implemented at a terminal device, comprising:
receiving a configuration from a network node,
wherein the configuration indicates the terminal device to perform Minimization of Drive Test, MDT, measurement and/or store the MDT measurement result only when location information is available, and/or indicates the terminal device to report only location information tagged MDT measurements.

2. The method according to claim 1, further comprising:
performing the MDT measurement and/or storing the MDT measurement result based on the configuration only when location information is available.

3. The method according to claim 1, further comprising:
transmitting a report comprising only location information tagged MDT measurement result, or all MDT measurement result regardless of location information tag, to the network node.

4. The method according to claim 1, wherein the configuration is carried in LoggedMeasurementConfiguration message and/or UeInformationRequest message.

5. The method according to claim 1, wherein the configuration comprises one or more indicators.

6. The method according to claim 5, wherein the indicator is LocationInfoOption.

7. The method according to claim 2, wherein before the step of performing the MDT measurement, the method further comprising determining whether location information is available.

8. The method according to claim 2, wherein before the step of storing the MDT measurement result, the method further comprising determining whether the MDT measurement result is tagged with location information.

9. The method according to claim 1, wherein the location information comprises at least one of: Global Navigation Satellite System, GNSS, information, Wireless Local Area Network, WLAN, information, and Bluetooth beacon information.

10. The method according to claim 1, further comprising:
transmitting an indication of existence of MDT measurement result with location information to the network node.

11. The method according to claim 10, wherein the indication is carried in at least one of: RRCSetupComplete message, RRCResumeComplete message, RRCReconfigurationComplete message, or RRCReestablishmentComplete message.

12. The method according to claim 3, wherein the location information tagged MDT measurement result in the report is for a different network node other than the network node.

13. The method according to claim 3, wherein the report is carried in a UeInformationResponse message.

14. The method according to claim 3, wherein before the step of transmitting the report to the network node, the method further comprising filtering for the location information tagged MDT measurement result.

15. An apparatus implemented in a terminal device, comprising:
one or more processors; and
one or more memories comprising computer program codes,
the one or more memories and the computer program codes configured to, with the one or more processors, cause the apparatus at least to:
receive a configuration from a network node,
wherein the configuration indicates the terminal device to perform Minimization of Drive Test measurement and/or store the MDT measurement result only when location information is available, and/or indicates the terminal device to report only location information tagged MDT measurements.

16. (canceled)

17. A method implemented at a network node, comprising:
determining a configuration which indicates a terminal device to perform Minimization of Drive Test (MDT) measurement and/or store the MDT measurement result only when location information is available, and/or indicates the terminal device to report only location information tagged MDT measurements; and
transmitting the configuration to the terminal device.

18. The method according to claim 17, further comprising:
receiving a report comprising only location information tagged MDT measurement result, or all MDT measurement result regardless of location information tag, from the terminal device.

19. The method according to claim 17, wherein the configuration is carried in LoggedMeasurementConfiguration message and/or UeInformationRequest message.

20-22. (canceled)

23. The method according to claim 17, further comprising:
receiving an indication of existence of MDT measurement result with location information from the terminal device.

24-32. (canceled)
